(19) United States
(12) Patent Application Publication
(10) Pub. No.: US 2025/0111572 A1
(43) Pub. Date: Apr. 3, 2025

(54) MODEL DATA CONTROL METHOD AND MODEL DATA CONTROL DEVICE

(71) Applicant: Yamaha Corporation, Hamamatsu (JP)

(72) Inventors: Takuma TAKEMOTO, Hamamatsu (JP); Takuya FUJISHIMA, Hamamatsu (JP); Akira MAEZAWA, Hamamatsu (JP); Norihiro UEMURA, Hamamatsu (JP); Yoshinari NAKAMURA, Hamamatsu (JP); Yuki YAMAMOTO, Tokyo (JP)

(21) Appl. No.: 18/978,362

(22) Filed: Dec. 12, 2024

Related U.S. Application Data
(63) Continuation of application No. PCT/JP2023/018299, filed on May 16, 2023.

(30) Foreign Application Priority Data
Jun. 15, 2022 (JP) 2022-096218

(51) Int. Cl. G06T 13/40; G06T 19/20; G06V 10/82; G10H 1/00

(52) U.S. Cl. CPC G06T 13/40; G06T 19/20; G10H 1/00; G06T 2219/2016; G06V 10/82

(57) ABSTRACT

A model data control method includes receiving first model data of a performer and second model data of an instrument, receiving calibration data related to a size of the performer or the instrument, receiving motion data of the performer, correcting the first model data or the second model data, using the calibration data, rendering the first model data and the second model data after the correcting, and controlling the first model data using the motion data

### CROSS-REFERENCE TO RELATED APPLICATIONS

This application is a continuation application of International Application No. PCT/JP2023/018299, filed on May 16, 2023, which claims priority to Japanese Patent Application No. 2022-096218 filed in Japan on Jun. 15, 2022. The entire disclosures of International Application No. PCT/JP2023/018299 and Japanese Patent Application No. Jun. 15, 2022 are hereby incorporated herein by reference.

### BACKGROUND

### Technical Field

One embodiment of this disclosure relates to a model data control method and a model data control device.

### Background Information

Japanese Laid-Open Patent Publication No. H10 (1998)-307930 discloses a configuration in which motion data are temporally compressed or stretched on the basis of MIDI data to synchronize musical timings.

Japanese Laid-Open Patent Publication No. H9 (1997)-198522 discloses a configuration in which the time length of motion data of a mouth is controlled on the basis of sound data.

Japanese Laid-Open Patent Publication No. 2003-67773 discloses a configuration in which, when blending first motion data and second motion data, the individual blending rate of the second motion data is set high for the Mth bone of a skeleton, and the individual blending rate of the second motion data is set low for the Nth bone.

International Publication No. 2017/029915 discloses a configuration in which an effect is applied to a virtual image of a performer's hand on the basis of a performer's motion and body information.

### SUMMARY

None of the configurations disclosed in Japanese Laid-Open Patent Publication No. H10 (1998)-307930, Japanese Laid-Open Patent Publication No. H9 (1997)-198522, Japanese Laid-Open Patent Publication No. 2003-67773, and International Publication No. 2017/029915 corrects the dimension (size) of the instrument's model data and the size of the performer's model data. When the creators of the instrument's model data and the performer's model data are different, there are cases in which the sizes of the instrument's model data and the performer's model data are different. For that reason, there are cases in which a viewer senses unnaturalness when viewing the performer's model data and the instrument's model data in virtual space.

An object of one embodiment of this disclosure is to provide a model data control method that can more naturally express model data of a performer and an instrument.

A model data control method according to this disclosure comprises: receiving first model data of a performer and second model data of an instrument; receiving calibration data related to a size of the performer or the instrument; receiving motion data of the performer; and correcting the first model data or the second model data using the calibration data, rendering the first model data and the second model data after the correcting; and controlling the first model data using the motion data.

### BRIEF DESCRIPTION OF THE DRAWINGS

FIG. 1 is a block diagram showing a configuration of a model data control system 1.

FIG. 2 is a block diagram showing a configuration of a guitar amplifier 11.

FIG. 3 is a block diagram showing a configuration of a user terminal 12.

FIG. 4 is a functional block diagram of an application program.

FIG. 5 is a flowchart showing an operation of a model data control method.

FIG. 6 is a schematic diagram of model data.

FIG. 7 is a block diagram of a user terminal 12A according to a second modified example.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

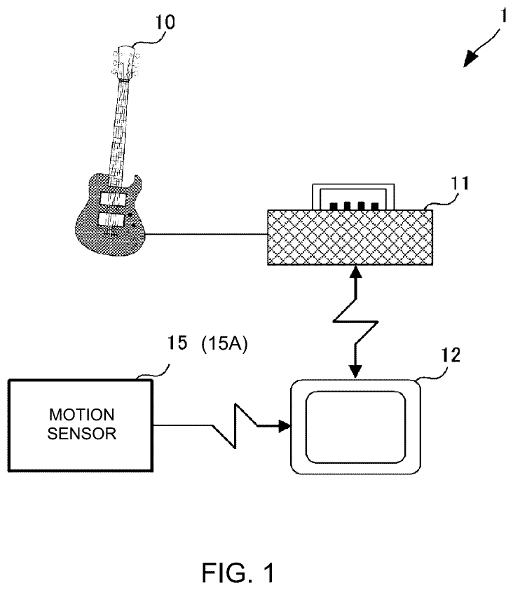

FIG. 1 is an external view showing one example of a model data control system 1. The model data control system 1 comprises an electric guitar 10, a guitar amplifier 11, a user terminal 12, and a motion sensor 15. The guitar amplifier 11 is not essential in this disclosure. The electric guitar 10 can be connected to the user terminal 12 without the guitar amplifier 11 interposed therebetween.

The electric guitar 10 is one example of a string instrument. In the present embodiment, the electric guitar 10 is presented as an example of a musical instrument, but the musical instrument of this disclosure also includes, for example, an electric bass, and acoustic instruments such as a violin. In addition, the musical instrument of this disclosure is not limited to a string instrument. The musical instrument of this disclosure includes other types of instruments, such as keyboard instruments and wind instruments.

The guitar amplifier 11 is connected to the electric guitar 10 via an audio cable. In addition, the guitar amplifier 11 is connected to the user terminal 12 by wireless communication, such as Bluetooth (registered trademark) or wireless LAN. Of course, the guitar amplifier 11 can be connected to the user terminal 12 via a communication cable. The electric guitar 10 outputs, to the guitar amplifier 11, an analog sound signal related to a performance sound. When the string instrument is an acoustic instrument, a sound signal is input to the guitar amplifier 11 using a microphone or a magnetic pickup.

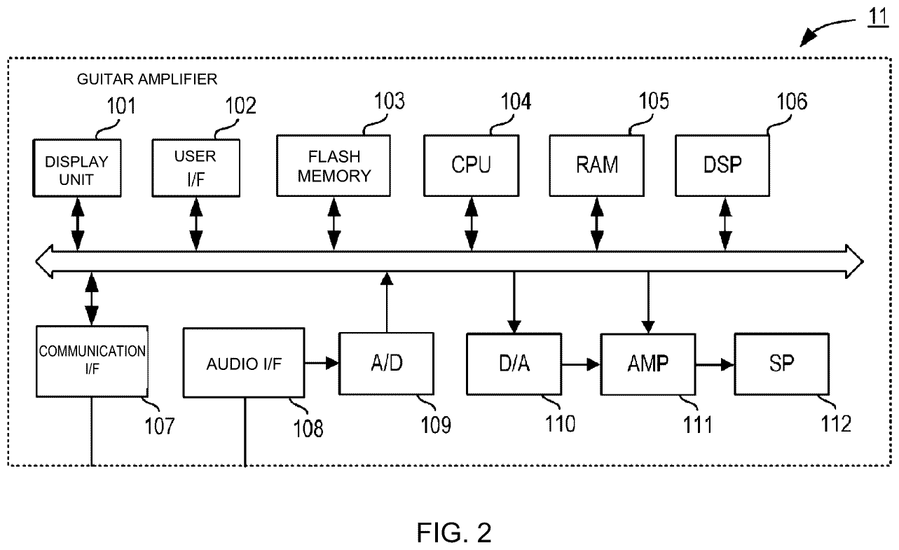

FIG. 2 is a block diagram showing a configuration of the guitar amplifier 11. The guitar amplifier 11 comprises a display unit 101, a user interface (I/F) 102, a flash memory 103, a CPU (Central Processing Unit) 104, a RAM (Random Access Memory) 105, a DSP (Digital Signal Processor) 106, a communication I/F (interface) 107, an audio I/F (interface) 108, an A/D converter (analog-to-digital converter) 109, a D/A converter (digital-to-analog converter) 110, an amplifier (AMP) 111, and a speaker (SP) 112.

The display unit 101 includes an LED (light-emitting diode), a liquid crystal display (LCD) or an organic light-emitting diode (OLED), for example, and displays the state of the guitar amplifier 11, and the like.

The user I/F 102 includes f nobs, switches, or buttons, etc., and receives user operations. In addition, the user I/F 102 can be a touch panel stacked on an LCD of the display unit 101.

The CPU 104 reads, into the RAM 105, various programs stored in the flash memory 103, which is a storage medium, to control the guitar amplifier 11. For example, the CPU 104 receives parameters related to signal processing via the user I/F 102 and controls the DSP 106 and the amplifier 111.

The communication I/F 107 is connected to other devices, such as the user terminal 12, via Bluetooth (registered trademark), wireless LAN, or the like.

The audio I/F 108 has an analog audio terminal. The audio I/F 108 receives an analog sound signal from the electric guitar 10 via an audio cable.

The A/D converter 109 converts the analog sound signal received by the audio I/F 108 to a digital sound signal.

The DSP 106 applies various signal processing, such as effects, to said digital sound signal. Parameters related to signal processing are received via the user I/F 102. The DSP 106 outputs, to the D/A converter 110, the digital sound signal after the signal processing has been applied thereto.

The CPU 104 transmits, to the user terminal 12 via the communication I/F 107, the digital sound signal after signal processing has been applied by the DSP 106, or the digital sound signal before the signal processing is applied.

The D/A converter 110 converts the digital sound signal received from the DSP 106 to an analog sound signal. The amplifier 111 amplifies said analog sound signal. Parameters related to amplification are received via the user I/F 102.

The speaker 112 outputs the performance sound of the electric guitar 10 on the basis of the analog sound signal amplified by the amplifier 111.

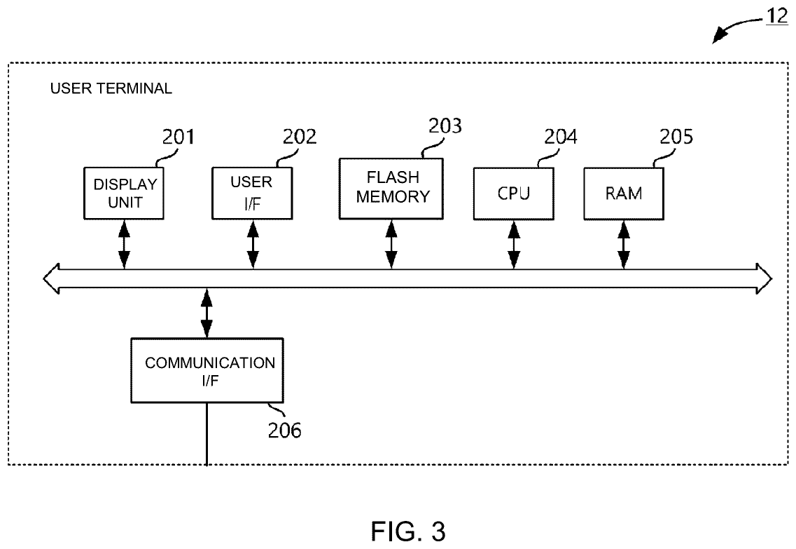

FIG. 3 is a block diagram showing a configuration of the user terminal 12. The user terminal 12 is an information processing device, such as a personal computer or a smartphone. The user terminal 12 is a model data control device of this disclosure. The user terminal 12 comprises a display unit 201, a user I/F (interface) 202, a flash memory 203, a CPU 204 (Central Processing Unit), a RAM (Random Access Memory) 205, and a communication I/F (interface) 206.

A user of the user terminal 12 in the present embodiment is a player of the electric guitar 10. The player of the electric guitar 10 uses the user terminal 12 to distribute the performer's own performance sound, as well as to cause a 3D model to move, the 3D model being the performer's own alter ego that performs virtually in a virtual space. The user terminal 12 generates motion data for controlling the movements of the 3D model. The user terminal 12 reads, from the flash memory 203 into the RAM 205, application programs for distributing performance sounds, generating motion data, and controlling 3D models, and executes the application programs.

The display unit (display) 201 includes an LED, an LCD, or an OLED, and displays various information. The user I/F 202 is a touch panel stacked on the LCD or the OLED of the display unit 201. Alternatively, the user I/F 202 can be a user operable input such as a keyboard, a mouse, or the like. When the user I/F 202 is a touch panel, the user I/F 202 constitutes a graphic user interface (GUI), together with the display unit 201.

The communication I/F 206 is connected to the guitar amplifier 11 and the motion sensor 15 via wireless communication, such as Bluetooth (registered trademark) or wireless LAN.

The CPU 204 is an electronic controller for controlling the operation of the user terminal 12. The CPU 204 reads, into the RAM 205, a prescribed program, such as an application program stored in the flash memory 203, which is a storage medium, and executes the program to perform various operations. The program can be stored in a sever (not shown). The CPU 204 can download the program from a server via a network and execute the program. The CPU 204 executes the application program to execute the model data control method. The term “electronic controller” as used herein refers to hardware that executes software programs. The electronic controller can be configured to comprise, instead of the CPU 204 or in addition to the CPU 204, programmable logic devices such as a DSP (Digital Signal Processor), an FPGA (Field Programmable Gate Array), and the like. In addition, the electronic controller can include a plurality of CPUs (or a plurality of programmable logic devices). As the storage medium, such as a magnetic storage medium or a semiconductor storage medium, or a combination of a plurality of various types of storage media can be freely employed.

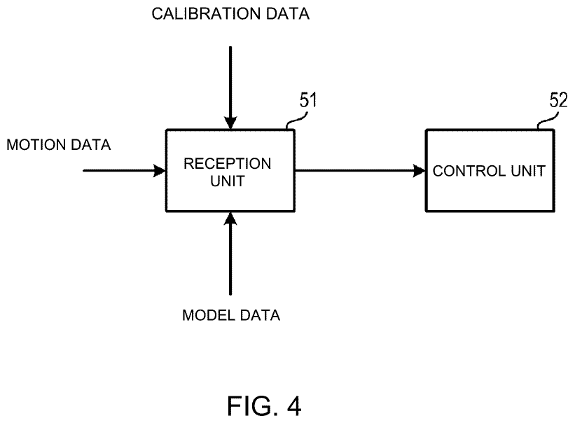

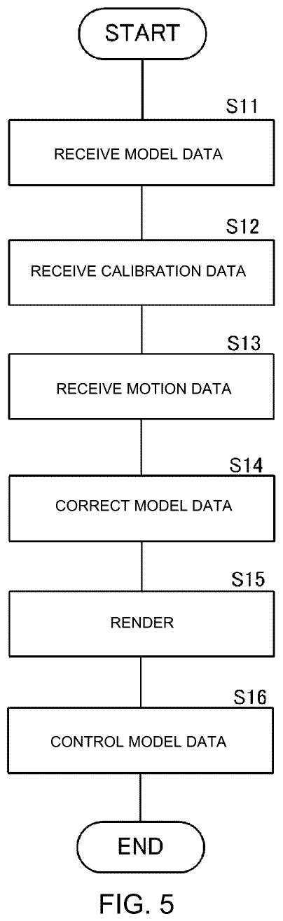

FIG. 4 is a functional block diagram of the application program read by the CPU 204. FIG. 5 is a flowchart showing an operation of the model data control method. The CPU 204, with the application program that has been read, constitutes a reception unit 51 and a control unit (controller) 52.

The reception unit 51 receives model data, motion data, and calibration data (S11, S12, S13). The model data are image data for constructing a 3D model, and the like.

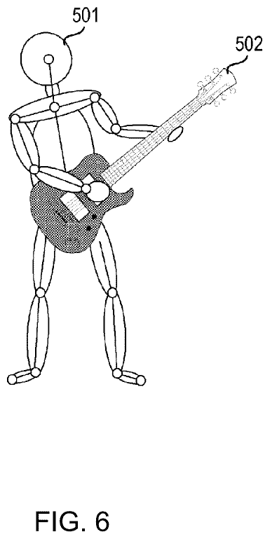

FIG. 6 is a schematic diagram of the model data. The model data include a first model data 501 of a performer and a second model data 502 of an instrument.

The first model data 501 are downloaded from another device, such as an undiagrammed server (for example, a computer used by a creator) and stored in the flash memory 203.

The first model data 501 include a plurality of pieces of polygon data and bone data for constructing, for example, a performer's face, torso, arms, fingers, and legs. The plurality of pieces of bone data have a linked structure, joined by a plurality of pieces of joint data.

Position information of each piece of bone data of the first model data 501 is defined by the motion data.

The second model data 502 are downloaded from another device, such as an undiagrammed server (for example, a computer used by an instrument manufacturer) and stored in the flash memory 203.

The second model data 502 include a plurality of pieces of polygon data and bone data for constructing, for example, a guitar's body, neck, and strings. The plurality of pieces of bone data have a linked structure, joined by a plurality of pieces of joint data. However, a guitar does not have any movable parts other than the strings, so that the linked structure is not essential. In cases of an instrument with movable parts, the second model data 502 preferably include a linked structure.

The motion data are input from the motion sensor 15. The motion sensor 15 is a sensor for capturing the performer's motion, and is, for example, an optical, inertial, or image sensor. The control unit 52 updates the position information of the bone data of the first model data 501, on the basis of the motion data received from the motion sensor 15.

The control unit 52 corrects, using the calibration data, at least one of the first model data 501 or the second model data 502, or both. More specifically, the control unit 52 corrects, using the calibration data, for example, at least one of the size of the first model data 501 or the size of the second model data 502, or both (S14). The size of the first model data 501 indicates, for example, a dimension (size) of the performer in the first model data 501, and the size of the second model data 502 indicates, for example, a dimension (size) of the instrument in the second model data 502. As described above, the first model data 501 are downloaded from a computer used by a creator, for example, and the second model data 502 are downloaded from a computer used by an instrument manufacturer. In this manner, when creators of the first model data 501 and the second model data 502 are different, there are cases in which the sizes of the first model data 501 and the second model data 502 are different. Therefore, there are cases in which a viewer senses unnaturalness when viewing a performer's 3D model and an instrument's 3D model in virtual space.

Therefore, the control unit 52 corrects the size of the first model data 501 or the second model data 502, or both using the calibration data. The calibration data are data pertaining to a size(s) of the performer or the instrument. For example, a user of the user terminal 12 inputs the user's own height and the length of the neck of the electric guitar 10 via the user I/F 202. The control unit 52 corrects the sizes of the first model data 501 or the second model data 502 in accordance with the height and the neck length that have been input. For example, the control unit 52 corrects the length of each piece of bone data of the first model data 501 based on the ratio between the height that has been input and the height of the first model data 501. In addition, the control unit 52 corrects the size of each piece of bone data of the second model data 502 based on the ratio between the neck length of the second model data 502 and the neck length of the electric guitar 10 that has been input.

The user can simply input the neck length of the instrument. In this case, the control unit 52 accepts the height of the user to be a generic height (for example, the average height of an adult male or female).

Finally, the control unit 52 renders the first model data 501 and the second model data 502 (S15) after the correction, and uses the motion data to control each piece of bone data of the first model data 501 (S16).

In this manner, the model data control method of the present embodiment can correct the size of the first model data 501 or the size of the second model data 502, or both to more naturally express the model data of the performer and the instrument, even if the sizes of the first model data 501 and the second model data 502 are different. Accordingly, the user of the model data control method of the present embodiment can enjoy a customer experience of being able to provide a virtual performance in a virtual space with more sense of presence.

### First Modified Example

In the embodiment described above, the user of the user terminal 12 inputs the neck length of the electric guitar 10 via the user I/F 202. In the first modified example, the user of the user terminal 12 inputs information relating to a product name of the electric guitar 10 via the user I/F 202. The control unit 52 receives information pertaining to the product name of the instrument input by the user. The control unit 52 determines the calibration data related to the size of the instrument on the basis of the information pertaining to the product name. For example, the control unit 52 transmits the information pertaining to the product name to another device such as an undiagrammed server (computer used by an instrument manufacturer). The server has a database in which product names of musical instruments are associated with size information of components, including necks. The control unit 52 receives, from the database on the server, data (for example, information on neck length) related to the size of the instrument corresponding to the product name.

The user can thereby input calibration data without measuring and inputting the neck length of the electric guitar 10.

### Second Modified Example

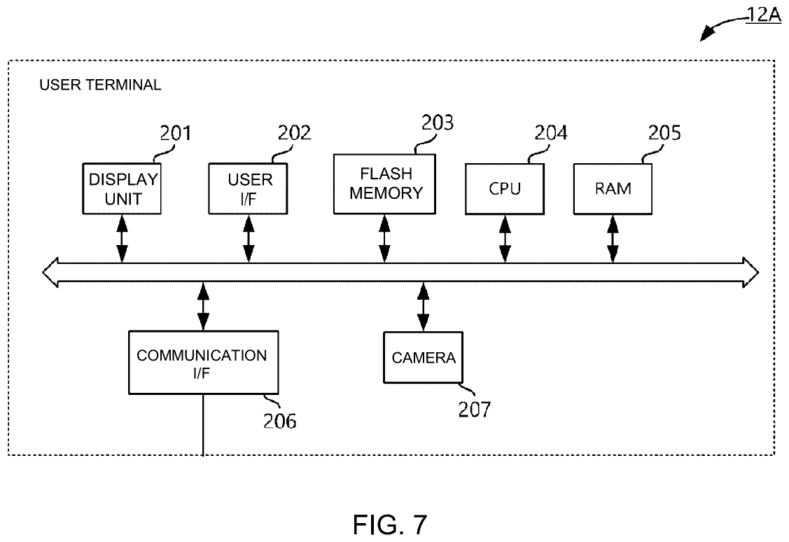

FIG. 7 is a block diagram of a user terminal 12A according to the second modified example. The configurations that are the same as those of the user terminal 12 in FIG. 3 have been assigned the same reference numerals and their descriptions have been omitted.

The user terminal 12A further comprises a camera 207. The user uses the camera 207 of the user terminal 12A to photograph the electric guitar 10.

The control unit 52 obtains information pertaining to the product name of the corresponding instrument, on the basis of image data of the musical instrument photographed with the camera 207. For example, the control unit 52 obtains information pertaining to the product name of the musical instrument on the basis of a trained model that has been trained on the relationship between image data of photographs of instruments and information pertaining to product names of instruments, using a deep neural network (DNN). The training is realized in advance by a program that is executed on a computer (server) used by an instrument manufacturer, for example.

Then, the control unit 52 determines the calibration data related to the size of the instrument on the basis of the information pertaining to the product name obtained using the trained model, in the manner shown in the first modified example.

As a result, the user can simply photograph the instrument with the camera 207 to input the calibration data, eliminating the need to manually input the instrument name.

### Third Modified Example

The user terminal 12 according to the third modified example determines the calibration data on the basis of a sound signal related to a performance sound. Specifically, the user, who is the player, plays the electric guitar 10 using a specific playing technique. A specific playing technique is, for example, holding the first fret of the sixth string with the index finger of the left hand, holding the fret of the first string that is within the reach with the little finger of the left hand, and plucking the strings with the right hand.

The user terminal 12 receives a special performance sound that is generated when playing using said specific playing technique. The user terminal 12 determines the calibration data related to the size of the performer on the basis of the special performance sound that has been received. For example, the control unit 52 determines the calibration data on the basis of a trained model that has been trained on the relationship between special performance sounds and calibration data related to sizes of performers, using a DNN. The training is realized in advance by a program that is executed on a computer (server) used by an instrument manufacturer, for example.

Fret positions that can be reached with the little finger of the left hand differ depending on the size of the performer's hand. For example, a performer who can reach the third fret of the first string has a larger hand than a performer who can only reach the first fret of the first string. The size of the hand and the sound played when the first fret of the first string is played (pitch of F4), and the size of the hand and the sound played when the third fret of the first string is played (pitch of G4), respectively, can be uniquely associated with each other. That is, there is a correlation between the special performance sound produced when playing using the specific playing technique and the size of the performer's hand. Thus, a computer can train a prescribed model on the relationship between special performance sounds produced when playing using a specific playing technique and the sizes of performers' hands (calibration data related to the sizes of performers) to generate a trained model.

The control unit 52 of the user terminal 12 determines, as the calibration data, the size of the performer's hand determined using the trained model. The control unit 52 uses the information on the size of the performer's hand to correct the size of the first model data 501 or the second model data 502. For example, the control unit 52 corrects the length of each piece of bone data of the first model data 501 based on the ratio between the size of the performer's hand determined using the trained model and the size of the hand of the first model data 501.

As a result, the user can simply perform using a special playing technique to input the calibration data.

### Fourth Modified Example

In the model data control method of the present embodiment, it is not essential to correct the size of the first model data or the second model data using the calibration data. For example, in the model data control method of the present embodiment, the position of the first model data or the second model data can be corrected on the basis of the calibration data. The user terminal 12 according to the fourth modified example corrects the relative positional relationship between the first model data 501 and the second model data 502 on the basis of the calibration data. Specifically, the user terminal 12 sets a constraint condition on the relative positional relationship between the first model data 501 and the second model data 502. For example, the user terminal 12 always arranges the performer's first model data 501 behind the second model data 502, which represent a guitar. In addition, the user terminal 12 arranges the position of the bones of the left hand of the first model data 501 at the neck portion of the second model data 502. Additionally, the user terminal 12 arranges the part of the bones of the right hand of the first model data 501 that is close to the elbow in the upper portion of the body of the second model data 502.

More specifically, for example, the user terminal 12 arranges the fingertips of the left hand bones of the first model data on a fret on the neck of the second model data 502. For example, if the lengths of the fingers of the bones are completely different from the lengths of the actual fingers of the performer, there are cases in which, even if the performer places a fingertip on a fret position of the instrument, the position of the fingertip defined by the motion data is off the fret. However, the user terminal 12 can set a constraint condition to arrange the fingertips of the left hand bones of the first model data 501 on the frets on the neck of the second model data 502, to arrange the first model data 501 and the second model data 502 in more natural positions.

As a result, the user terminal 12 can place the second model data 502 of the musical instrument in a more natural position with respect to the first model data 501 of the performer.

As described above, the position information of each piece of bone data of the first model data 501 is defined by the motion data. The user terminal 12 according to the fourth modified example corrects the relative positional relationship between the first model data 501 and the second model data 502. Accordingly, the position information of the second model data 502 can also be defined by the motion data.

Therefore, the user terminal 12 according to the fourth modified example can determine the position and orientation of the second model data 502 without using a motion sensor that detects the position or orientation of the musical instrument.

### Fifth Modified Example

The user terminal 12 (the control unit 52 as a sound signal processing unit) of the fifth modified example estimates a sound emission position and a sound emission direction of a musical instrument on the basis of the second model data 502, receives a performance sound of the musical instrument, and carries out sound signal processing on the performance sound on the basis of the estimated sound emission position and sound emission direction.

As shown in the fourth modified example, the user terminal 12 can determine the position and orientation of the second model data 502 on the basis of the position information of the first model data 501, for example. For example, the user terminal 12 applies a sound image localization process, such as a panning process, on a sound signal related to a performance sound, on the basis of the position of the second model data 502.

For example, the user terminal 12 distributes the sound signal of the performance sound to the L and R channels, and adjusts the volume balance between the L and R channels on the basis of the position of the instrument. For example, when the position information of the second model data 502 is on the right side in the virtual space (right side as viewed from the listener), the user terminal 12 increases the volume of the R channel and decreases the volume of the L channel. As a result, the performance sound is localized on the right side as viewed from the listener. Accordingly, a listener of the performance sound can perceive the sound image as being localized at the position of the second model data 502 in the virtual space.

In addition, for example, the user terminal 12 can convolve a sound signal related to a performance sound with a head-related transfer function (HRTF) to apply a sound image localization process. A head-related transfer function is a transfer function from the sound source position to the listener's right and left ears. The user terminal 12 reads a head-related transfer function corresponding to the position information of the instrument from a server, or the like, and convolves the sound signal related to the performance sound with the head-related transfer function. Accordingly, a listener can perceive the sound image as being localized at the position of the second model data 502 in the virtual space.

In addition, the head-related transfer function can be different depending on the orientation of the instrument. The user terminal 12 reads a head-related transfer function corresponding to orientation information of the instrument from a server, or the like, and convolves the sound signal related to the performance sound with the head-related transfer function. As a result, a listener of the performance sound can perceive the sound image as being localized at the position of the second model data 502 in the virtual space, as well as perceive changes in sound caused by changes in the orientation of the instrument.

As a result, the listener can experience more realistic sound image localization, and have a customer experience that was not previously possible.

### Sixth Modified Example

The motion data can include data detected with a motion sensor 15A (FIG. 1) that detects the position or orientation of the musical instrument. The user terminal 12 can use the data detected with the motion sensor 15A to control the second model data 502. The motion sensor 15A in the sixth modified example includes a three-axis acceleration sensor and a position sensor. The three-axis acceleration sensor detects the orientation of the instrument. The position sensor detects the position of the instrument. The position sensor can be an indoor positioning sensor such as a Bluetooth (registered trademark) Low Energy (BLE) beacon, or an outdoor positioning sensor such as a Global Positioning System (GPS).

The user terminal 12 can receive the orientation of the instrument detected with the three-axis acceleration sensor and the position of the instrument detected with the position sensor to control the position and orientation of the second model data 502. In this case as well, the user terminal 12 preferably sets a constraint condition on the relative positional relationship between the first model data 501 and the second model data 502, as was shown in Modified Example 4. The user terminal 12 can place the first model data 501 of the performer and the second model data 502 of the musical instrument in more natural positions.

In addition, as shown in Fifth Modified Example, the user terminal 12 can receive the orientation of the instrument detected with the three-axis acceleration sensor and the position of the instrument detected with the position sensor to carry out sound signal processing on the performance sound in accordance with the position and orientation of the instrument.

According to one embodiment of this disclosure, it is possible to more naturally express model data of a performer and an instrument.

The description of the present embodiment is exemplary in all respects and should not be considered restrictive. The scope of the present invention is indicated by the Claims section, not the embodiment described above. Furthermore, the scope of the present invention includes the scope that is equivalent that of the Claims.

What is claimed is:

1. A model data control method comprising:
receiving first model data of a performer and second model data of an instrument;
receiving calibration data related to a size of the performer or the instrument;
receiving motion data of the performer;
correcting the first model data or the second model data, using the calibration data;
rendering the first model data and the second model data after the correcting; and
controlling the first model data using the motion data.

2. The model data control method according to claim 1, wherein
information pertaining to a product name of the instrument is received, and
the calibration data related to the size of the instrument is determined based on the information pertaining to the product name.

3. The model data control method according to claim 2, wherein
image data obtained by photographing the instrument are received, and
the information pertaining to the product name is determined based on the image data.

4. The model data control method according to claim 1, wherein
a special performance sound that is generated as the performer plays the instrument using a specific playing technique is received, and
the calibration data related to the size of the performer is determined based on the special performance sound.

5. The model data control method according to claim 1, wherein
a size of the first model data or the second model data, or a relative positional relationship between the first model data and the second model data, is corrected based on the calibration data related to the size of the performer or the instrument.

6. The model data control method according to claim 1, further comprising
estimating a sound emission position and a sound emission direction of the instrument based on the second model data,
receiving a performance sound of the instrument, and
carrying out sound signal processing on the performance sound based on the sound emission position and the sound emission direction that have been estimated.

7. The model data control method according to claim 6, wherein
the sound signal processing includes a localization process for localizing the performance sound at the sound emission position that has been estimated.

8. The model data control method according to claim 1, further comprising
controlling the second model data using the motion data, the motion data including data detected with a motion sensor configured to detect a position or orientation of the instrument.

9. A model data control device comprising:
an electronic controller including at least one processor,
the at least one processor being configured to
receive first model data of a performer and second model data of an instrument, calibration data related to a size of the performer or the instrument, and motion data of the performer,
perform correction of the first model data or the second model data, using the calibration data,
render the first model data and the second model data after the correction, and
control the first model data using the motion data.

10. The model data control device according to claim 9, wherein
the at least one processor is configured to receive information pertaining to a product name of the instrument, and determine the calibration data related to the size of the instrument based on the information pertaining to the product name.

11. The model data control device according to claim 10, wherein
the at least one processor is configured to receive image data obtained by photographing the instrument, and determine the information pertaining to the product name based on the image data.

12. The model data control device according to claim 9, wherein
the at least one processor is configured to receive a special performance sound that is generated as the performer plays the instrument using a specific playing technique, and determine the calibration data related to the size of the performer based on the special performance sound.

13. The model data control device according to claim 9, wherein
the at least one processor is configured to perform the correction of a size of the first model data or the second model data, or a relative positional relationship between the first model data and the second model data, based on the calibration data related to the size of the performer or the instrument.

14. The model data control device according to claim 9, wherein
the at least one processor is further configured to receive a performance sound of the instrument, and estimate a sound emission position and a sound emission direction of the instrument based on the second model data, and carry out sound signal processing on the performance sound based on the sound emission position and the sound emission direction that have been estimated.

15. The model data control device according to claim 14, wherein
the at least one processor is configured to carry out a localization process for localizing the performance sound at the sound emission position that has been estimated.

16. The model data control device according to claim 9, wherein
the motion data include data detected with a motion sensor configured to detect a position or orientation of the instrument, and
the at least one processor is further configured to control the second model data using the motion data.
